(19) United States
(12) Patent Application Publication
(10) Pub. No.: US 2002/0057462 A1
(43) Pub. Date: May 16, 2002

(54) On-line transmitting image capturing device

(76) Inventors: Kuo-Pin Wu, Taipei City (TW); Heng-Chang Pai, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,823

(22) Filed: Oct. 23, 2001

(30) Foreign Application Priority Data
Nov. 10, 2000 (TW) 089123782

(51) Int. Cl. H04N 1/00

(52) U.S. Cl. 358/402

(57) ABSTRACT

An image capturing device electrically connected to a servicing station, which is connected to a network. When the image capturing receives a start signal, the image capturing device starts to generate image data. After the image capturing generates image data, the image data is transmitted to the servicing station, and then the servicing station automatically transmits the image data to an on-line user client via the network according to an on-line user list.

### BACKGROUND OF INVENTION

1. Field of the Invention

The present invention relates to an image capturing device and more specifically, the present invention discloses an image capturing device having an on-line transmitting image data function.

2. Description of the Prior Art

A prior art image capturing device, such as a scanner or a digital camera, does not have an on-line transmitting image data function. After the image capturing device generates image data, to deliver the image data to an on-line user client via a network, a user has to store the image data at a predetermined location, such as a homepage, a network driver or a FTP server beforehand, otherwise he or she has to transmit the image data via e-mail. The image capturing device according to prior art is unable to transmit the image data to the on-line user client automatically when the image data is generated.

### SUMMARY OF INVENTION

It is therefore a primary objective of this invention to provide an image capturing device having an on-line transmitting image data function. After image data is generated, the image capturing device transmits the image data to the on-line user client automatically.

The present invention, briefly summarized, discloses an image capturing device electrically connected to a servicing station, which is connected to a network. When the image capturing receives a start signal, the image capturing device starts to generate image data. After the image capturing generates the image data, the image data is transmitted to a servicing station, and then the servicing station automatically transmits the image data to an on-line user client via the network according to an on-line user list.

This and other objectives of the present invention will no doubt become clear to those of ordinary skill in the art after reading the following detailed description of the preferred embodiment, which is illustrated in the various figures and drawings.

### BRIEF DESCRIPTION OF DRAWINGS

FIG. 1 is a schematic diagram of an image capturing device according to the present invention.

FIG. 2 is a function block diagram of the image capturing device shown in FIG. 1.

FIG. 3 is a data flow chart of the image capturing device shown in FIG. 1.

### DETAILED DESCRIPTION

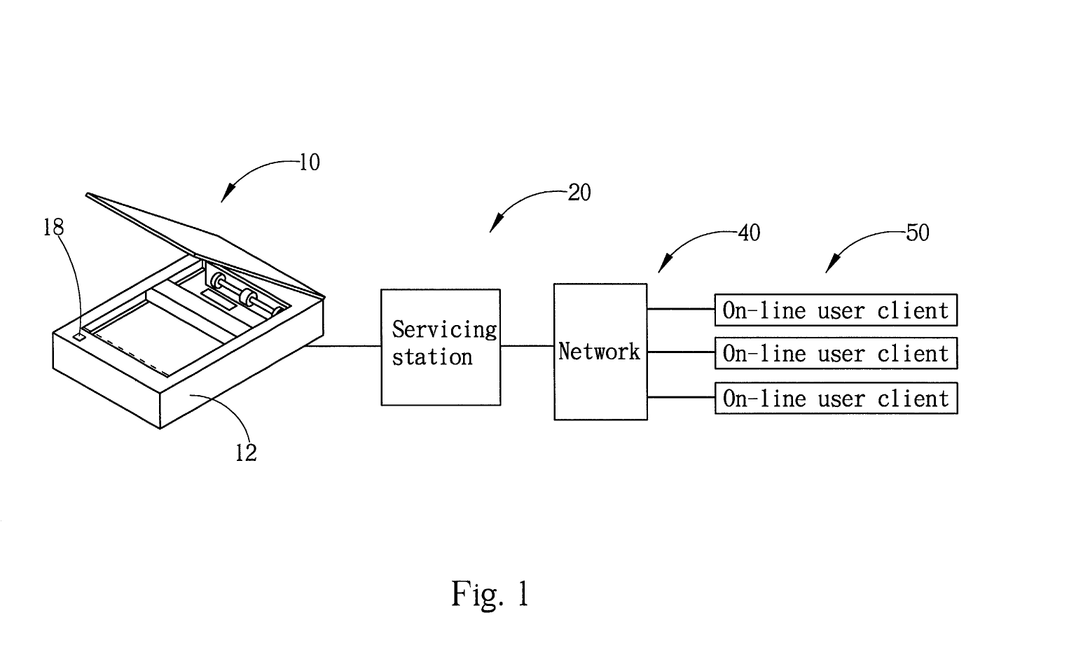

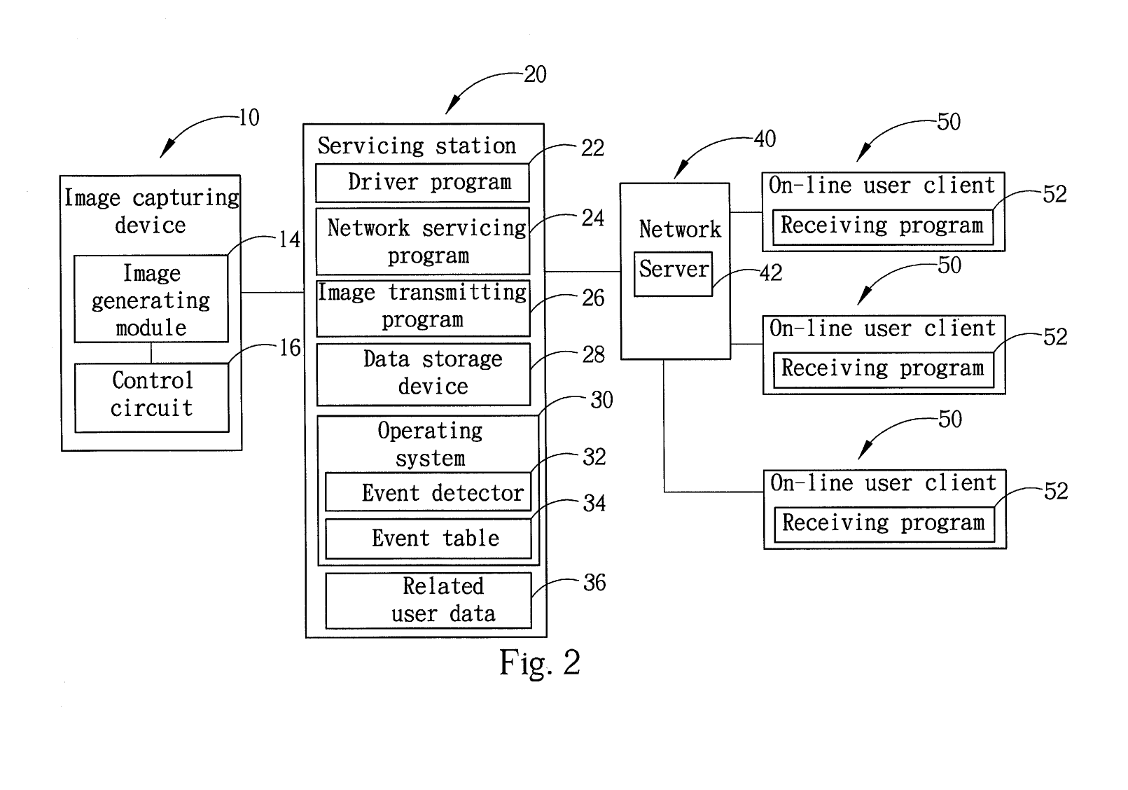

Please refer to FIG. 1 and FIG. 2. FIG. 1 is a schematic diagram of an image capturing device 10 according to the present invention. FIG. 2 is a function block diagram of the image capturing device 10. The image capturing device 10 is electrically connected to a servicing station 20 which is connected to a network 40. There is at least one on-line user client 50 connected to the network. The image capturing device 10 comprises a housing 12, an image generating module 14 installed inside the housing 12 for generating image data and transmitting the image data to the servicing station 20, a control circuit 16 for controlling operations of the image capturing device 10, and a button 18 installed on the housing 12 for generating a start signal. The start signal is transmitted to the control circuit 16. When the control circuit 16 receives the start signal, the control circuit 16 controls the image generating module 14 to generate image data and transmit the image data to the servicing station 20. In the embodiment, the image capturing device 10 is a scanner.

The servicing station 20 comprises a driver program 22 for commanding the control circuit 16 to control the operations of the image capturing device 10, a network servicing program 24 for controlling communications between the servicing station 20 and the network 40, and an image transmitting program 26 for transmitting the image data to the network 40. The network servicing program 24 detects the network 40 to provide an on-line user list. Some network programs, such as ICQ, have a dynamic link library (DLL) that can support an on-line user list supply function for providing the on-line user list by detecting the network 40 directly. The image transmitting program 26 transmits the image data to the on-line user client 50 via the network 40 according to the on-line user list.

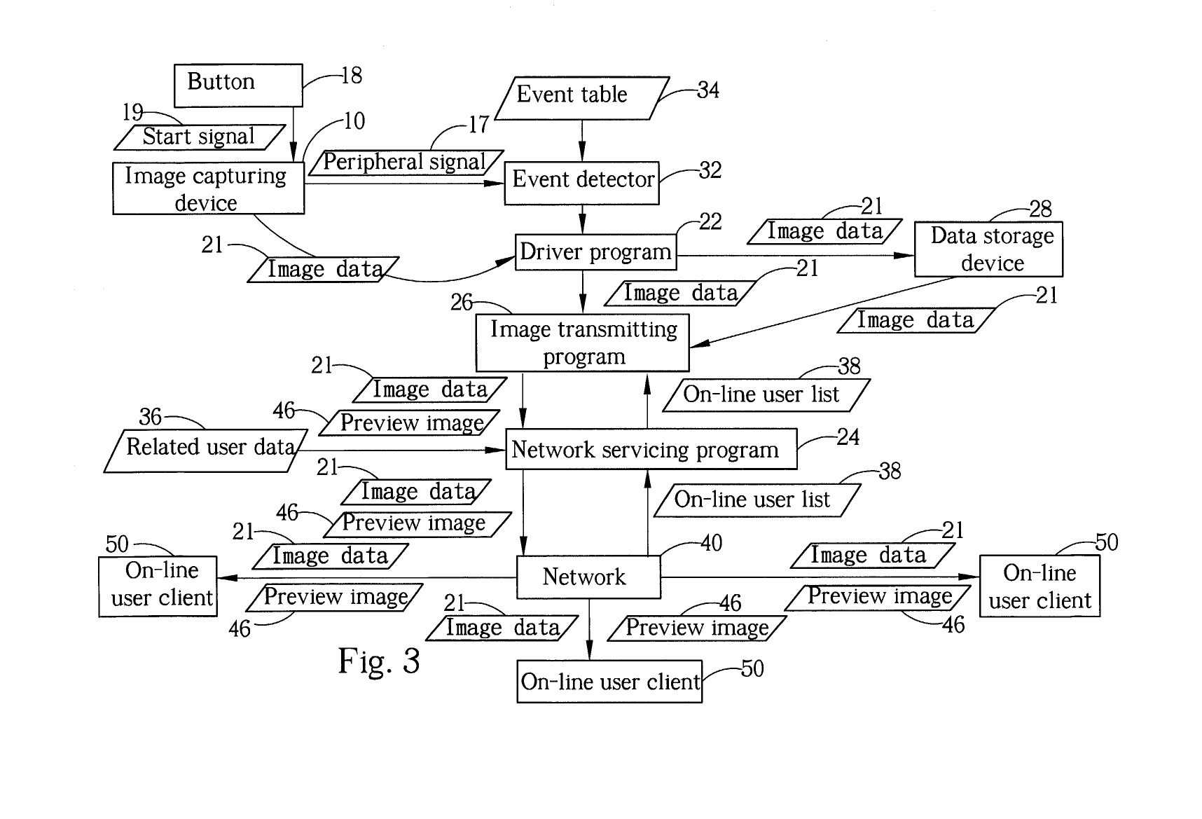

Please refer to FIG. 2 and FIG. 3. FIG. 3 is a data flow chart of the image capturing device 10. When a user presses the button 18, a start signal 19 is generated and transmitted to the control circuit 16 of the image capturing device 10. When the control circuit 16 receives the start signal 19, the control circuit 16 controls the image generating module 14 to generate an image data 21 and transmit the image data 21 to the driver program 22 of the servicing station 20.

The servicing station 20 comprises an operating system 30 for controlling operations of the servicing station 20. The operating system 30 comprises an event detector 32 and an event table 34. The event detector 32 is used to detect peripheral signals transmitted from peripheral devices connected to the servicing station 20 and handle communications between the servicing station 20 and the peripheral devices. The event table 34 is a data structure for defining corresponding events versus the peripheral signals and corresponding reactions of the events. When the control circuit 16 receives the start signal 19, the control circuit 16 transmits a peripheral signal 17 as an interrupt request to the event detector 32. The peripheral signal 17 comprises some information, such as eventtriggering information and identifying information of the image capturing device 10, and the event detector 32 can distinguish between various peripheral signals according to the information. When the event detector 32 receives the peripheral signal 17, the event detector 32 compares the triggering and identifying information of peripheral signal 17 with the event table 34, and then notifies the driver program 22 to receive the image data 21 from the image capturing device 10. Most operating systems, such as Microsoft Window 95/98/NT/2000, Unix and IBM OS/2, provide the functions of the event detector 32 and the event table 34, so as to control peripheral devices and deal with a variety of interrupt requests of the peripheral devices. Furthermore, the driver program 22 handles operations between the image capturing device 10 and the servicing station 20 using libraries of the operating system 30.

As described above, when the control circuit 16 receives the start signal 19, the control circuit 16 transmits the peripheral signal 17 as an interrupt request to the event detector 32 so as to notify the driver program 22 to receive the image data 21 from the image capturing device 10. Accepting this way to ascertain whether the image capturing device 10 generates the image data 21 or not when the control circuit 16 receives the start signal 19, the control circuit 16 changes a flag, and the event detector 32 periodically polls the flag to ascertain whether the flag has been changed. When the event detector 32 detects the flag has been changed, the event detector 32 notifies the driver program 22 to receive the image data 21 from the image capturing device 10.

The servicing station 20 further comprises a data storage device 28, such as dynamic memory or a magnetic media, for storing the image data 21 received from the driver program 22. Before the image transmitting program 26 transmits the image data 21 via the network servicing program 24, the image transmitting program 26 receives the image data 21 from the data storage device 28. When the image transmitting program 26 receives the image data 21 from the data storage device 28, the image data 21 stored in the data storage device 28 can be deleted so that the data storage device 28 can store data next time when the image capturing device 10 generates other image data. Following that, the image transmitting program 26 transmits the image data 21 to the on-line user client 50 via the network 40 according to the on-line user list 38 and corresponding network transmission protocol, such as TCP/IP (Transmission Control Protocol/Internet Protocol).

The servicing station 20 further comprises related user data 36, which records a plurality of user information. The network servicing program 24 provides the on-line user list 38 according to the related user data 36 so that the on-line user list 38 only lists on-line users with related user data 36 records. So, if the network servicing program 24 provides the on-line user list according to the related user data 36, the servicing station 20 transmits the image data 21 only to the particular on-line users with related user data 36 records. However, the network servicing program 24 not only provides the on-line user list 38 but also supports on-line chatting room and transmitting message functions so that the user of the servicing station 20 can communicate with the on-line user clients 50 immediately.

Each of the on-line user clients 50 comprises a receiving program 52 for receiving the image data 21 from the servicing station 20. Before the image transmitting program 26 transmits the image data 21 via the network servicing program 24, the image transmitting program 26 generates a preview image 46 for compensating a problem generated from a limited frequency band of the network 40 and for considering the receiving liberty of the on-line user client 50. The total data amount of the preview image 46 is less than the total data amount of the image data 21. The image transmitting program 26 transmits the preview image 46 to the on-line clients 50 via the network 40. When the on-line clients 50 receives the preview image 46, each of the receiving programs 52 shows the corresponding on-line user client 50 the preview image 46 so that each of the on-line user clients 50 is able to determine whether to receive the image data 21 or not after seeing the preview image 46.

As described above, the network servicing program 24 detects the network 40 directly to provide the on-line user list 38. Not only this, but the network servicing program 24 can also provide the on-line user list 38 via a server. As shown in FIG. 2, the network 40 further comprises a server 42, which provides registration and a network user groups service. When a user logs onto the server 42 and registers as a member, he or she can establish a network user group with other members, with the related user data 36 generated simultaneously. The network servicing program 24 transmits user information to the server 42 via the network 40, and the server 42 transmits the on-line user list 38 to the network servicing program 24 according to the related user data 36 so that the online user list 38 only lists on-line users with related user data 36 records.

In the embodiment, the image capturing device 10 is a scanner. In another embodiment, the image capturing device 10 could be a digital camera. The digital camera also has an on-line transmitting image data function like the scanner. After the digital camera generates image data 21, the image data 21 is automatically transmitted to the on-line user clients 50 via the servicing station 20 and the network 40.

In contrast to the prior art, the image capturing device 10 has on-line transmitting image data function. After a user presses the button 18 on the image capturing device 10, the image capturing device 10 starts to generate the image data 21 and automatically transmits the image data 21 to the on-line user clients 50 via the servicing station 20.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An image capturing device electrically connected to a servicing station, the servicing station connected to a network, an on-line user client connected to the network, the image capturing device comprising:
a housing;
an image generating module installed inside the housing for generating image data and transmitting the image data to the servicing station; and
a control circuit installed inside the housing and electrically connected to the image generating module for controlling operations of the image capturing device;
the servicing station comprising:
a driver program for commanding the control circuit to control the operations of the image capturing device;
a network servicing program for controlling communications between the servicing station and the network and providing an on-line user list; and
an image transmitting program for transmitting the image data via the network;
wherein when the control circuit receives a start signal, the control circuit controls the image generating module to generate the image data and transmit the image data to the servicing station, and then the image transmitting program transmits the image data to the on-line user client via the network according to the on-line user list.

2. The image capturing device of claim 1 further comprising a button installed on the housing for generating the start signal.

3. The image capturing device of claim 1 wherein the servicing station further comprises an event detector, and when the control circuit receives the start signal, the control circuit transmits a peripheral signal to the event detector, and then the event detector notifies the driver program to receive the image data from the image capturing device.

4. The image capturing device of claim 3 wherein when the control circuit receives the start signal, the control circuit generates an interrupt request to the servicing station.

5. The image capturing device of claim 3 wherein when the control circuit receives the start signal, a flag is changed, and the event detector periodically polls the flag to ascertain whether the flag has been changed.

6. The image capturing device of claim 3 wherein the servicing station further comprises an event table, and when the event detector receives the peripheral signal, the event detector notifies the driver program to receive the image data from the image capturing device according to the event table.

7. The image capturing device of claim 6 wherein the servicing station further comprises an operating system, the event table being built into the operating system.

8. The image capturing device of claim 1 wherein the image transmitting program transmits the image data to the on-line user client via the network servicing program.

9. The image capturing device of claim 6 wherein the servicing station further comprises a data storage device, and when the driver program receives the image data, the image data is stored in the data storage device, the image transmitting program receiving the image data from the data storage device.

10. The image capturing device of claim 9 wherein when the image transmitting program receives the image data from the data storage device, the image data stored in the data storage device is deleted.

11. The image capturing device of claim 9 wherein the data storage device is dynamic memory or a magnetic media.

12. The image capturing device of claim 1 wherein the servicing station further comprises related user data which records a plurality of user information, the network servicing program providing the on-line user list according to the related user data so that the on-line user list only lists on-line users with related user data records.

13. The image capturing device of claim 1 wherein the network further comprises a server, the on-line user list being received from the server, the network servicing program transmitting user information to the server via the network, and then the server transmitting the on-line user list to the network servicing program.

14. The image capturing device of claim 13 wherein the server further comprises related user data which records a plurality of user information, the server providing the on-line user list to the network servicing program according the related user data so that the on-line user list only lists on-line users with related user data records.

15. The image capturing device of claim 14 wherein the server provides registration and a network user groups service.

16. The image capturing device of claim 1 wherein the network servicing program detects the network directly to provide the on-line user list.

17. The image capturing device of claim 1 wherein the on-line user client comprises a receiving program for receiving the image data from the servicing station.

18. The image capturing device of claim 17 wherein the image transmitting program generates a preview image, a total data amount of the preview image being less than a total data amount of the image data, the image transmitting program transmitting the preview image to the on-line client via the network before transmitting the image data, the receiving program showing the on-line user client the preview image after the receiving program receives the preview image, the on-line user client being able to determine whether to receive the image data or not after seeing the preview image.

19. The image capturing device of claim 1 wherein the image capturing device is a scanner.

20. The image capturing device of claim 1 wherein the image capturing device is a digital camera.
